(19) United States
(12) Patent Application Publication
(10) Pub. No.: US 2013/0299082 A1
(43) Pub. Date: Nov. 14, 2013

(54) THREE DIMENSIONAL DISPLAY DEVICE AND MANUFACTURING METHOD THEREOF

(71) Applicant: JAPAN DISPLAY EAST INC., Mobara-shi (JP)

(72) Inventors: Hiroyuki YAMAZAKI, Chiba-shi (JP); Setsuo KOBAYASHI, Mobara-shi (JP); Takeharu FURUSAWA, Mobara-shi (JP); Sakae ISHII, Mobara-shi (JP)

(73) Assignee: JAPAN DISPLAY EAST INC., Mobara-shi (JP)

(21) Appl. No.: 13/834,656

(22) Filed: Mar. 15, 2013

(30) Foreign Application Priority Data
May 9, 2012 (JP) 2012-107690

(51) Int. Cl. G02F 1/1333

(52) U.S. Cl. CPC G02F 1/1333
USPC 156/275.5

(57) ABSTRACT

A liquid crystal parallax barrier panel and a liquid crystal display panel are held by vacuum-holding, and aligned so as to be laminated via an adhesive. After the lamination, the vacuum-holding is released. Then lamination of the liquid crystal display panel and the liquid crystal parallax barrier panel is finely adjusted, and the adhesive is temporarily cured by radiating ultraviolet rays. The adhesive is primarily cured and further thermally cured by ultraviolet rays to complete manufacturing of a three dimensional display device. Release of the vacuum-holding before temporary adhesion using ultraviolet rays allows suppression of deformation of a TFT substrate owing to the vacuum-holding as well as the gap unevenness and the color shading of the liquid crystal panel.

### CLAIM OF PRIORITY

The present application claims priority from Japanese Patent Application JP 2012-107690 filed on May 9, 2012, the content of which is hereby incorporated by reference into this application.

### BACKGROUND OF THE INVENTION

1. Technical Field

The present invention relates to a display device, and more particularly, the present invention relates to a method of manufacturing a three dimensional display device using a liquid crystal parallax barrier panel.

2. Related Art

A parallax barrier method is well known for displaying the three dimensional images without using the three dimensional eyeglasses. The parallax barrier method arranges longitudinally cut strip images from right and left eyes alternately to the rear of the plate having a plurality of longitudinal thin slits, which is called a parallax barrier panel so that those images are displayed as the three dimensional images via the parallax barrier panel.

Japanese Unexamined Patent Application Publication No. Hei 3-119889 discloses the structure of the three dimensional display device that allows display of both the two dimensional and three dimensional images through the parallax barrier panel formed by using the liquid crystal. Japanese Unexamined Patent Application Publication (Translation of PCT Application) No. 2009-524098 discloses the three dimensional display device using the parallax barrier, configured to align the parallax barrier panel with the liquid crystal display panel while observing the images for left and right eyes without using the alignment mark.

The parallax barrier panel using the liquid crystal (hereinafter referred to as the liquid crystal parallax barrier panel) has an advantage of easily selecting the image to be displayed between the two dimensional images and three dimensional images. Meanwhile, the three dimensional display device of parallax barrier type is required to accurately perform alignment of the liquid crystal display panel with the parallax barrier panel in addition to the liquid crystal parallax barrier panel.

Generally, the three dimensional display device using the liquid crystal parallax barrier panel is configured by producing the liquid crystal parallax barrier panel and the liquid crystal display panel separately, and adhering those panels via an adhesive formed of the ultraviolet curing resin applied to the liquid crystal parallax barrier panel. FIG. 12 shows a chart of generally employed process steps of adhering the liquid crystal parallax barrier panel and the liquid crystal display panel.

Referring to FIG. 12, the “adsorption” denotes the step of vacuum-holding the liquid crystal parallax barrier panel and the liquid crystal display panel so as to be carried while being held. The “alignment” shown in FIG. 12 denotes the step of aligning the liquid crystal parallax barrier panel with the liquid crystal display panel using the alignment mark and the like. Thereafter, the adhesive formed of the ultraviolet curing resin is temporarily cured by radiated ultraviolet rays. At this time, the liquid crystal parallax barrier panel and the liquid crystal display panel are vacuum-held so as to prevent misalignment thereof.

Thereafter, the vacuum-holding plate is removed, and the adhesive is primarily cured by the radiated ultraviolet rays. After thermally curing the adhesive, the three dimensional display device is visually inspected, and then subjected to the lighting inspection in order to inspect whether there is any color shading owing to abnormality in the liquid crystal display panel or the like. Finally, the observation inspection is conducted in order to confirm whether or not the three dimensional image has been produced by a predetermined operation. The inspection is conducted because the misalignment of the liquid crystal parallax barrier panel and the liquid crystal display panel may disable provision of the predetermined three dimensional images.

The “alignment” step and the “temporary curing” step of an adhesive 50 by ultraviolet rays are conducted while fixing a liquid crystal parallax barrier panel 20 and a liquid crystal display panel 10 through the vacuum-holding as shown in FIG. 13. Referring to FIG. 13, arrow marks from adsorption holes 110 of vacuum-holding plates 100 and codes VC indicate the state where the liquid crystal parallax barrier panel 20 and the liquid crystal display panel 10 are vacuum-held.

The three dimensional display device is required to have the reduced thickness. For this, each substrate of the liquid crystal display panel 10 and the liquid crystal parallax barrier panel 20 has to be made thin. For example, after adhering a TFT substrate 11 and a color filter substrate 12 of the liquid crystal display panel 10, the respective outer surfaces of the TFT substrate 11 and the color filter substrate 12 are ground to be thin. The substrate originally with thickness of approximately 0.5mm is ground to the thickness of 0.2 mm or smaller. The substrate with thickness of 0.2 mm or smaller is very likely to be bent under the external force although it is made of glass.

FIG. 14 is a cross section schematically showing the state where the liquid crystal display panel 10 is adsorbed to the vacuum-holding plate 100 via the adsorption hole 110. Referring to FIG. 14, a lower polarizing plate 31 has the thickness of approximately 0.13 mm, and the TFT substrate 11 has the thickness of approximately 0.18 mm. Even if they are laminated together, they are still flexible. The TFT substrate 11 is bent downward at the part corresponding to the adsorption hole 110. The thickness of a liquid crystal layer 40 of the liquid crystal display panel 10 is increased at this part. Especially, the liquid crystal display panel 10 of IPS (In Plane Switching) type or VA (Vertical Alignment) type using the birefringence mode is likely to be influenced by the layer thickness of the liquid crystal layer 40.

The part of the liquid crystal layer 40 having the increased thickness tends to cause the color shading of yellowing. FIG. 15 is a view schematically showing the state of the yellowed part of a display region 200 at the position corresponding to the adsorption hole 110 of the vacuum-holding plate 100 resulting from the increased thickness of the liquid crystal layer 40. The color shading occurs in various locations in accordance with the vacuum-holding condition rather than the given location as shown in FIG. 15. The color shading is not limited to the yellowish discoloration.

### SUMMARY OF THE INVENTION

The present invention provides the three dimensional display device using the liquid crystal parallax barrier panel 20, which provides images with no color shading.

The present invention provides a method of manufacturing a three dimensional display device, which adheres a liquid crystal parallax barrier panel with a barrier substrate and a counter substrate to a liquid crystal display panel with a TFT substrate and a color filter substrate at a side of the color filter substrate using an adhesive formed of an ultraviolet curing resin, and provides a backlight below a back surface of the liquid crystal display panel. The method includes the steps of holding the liquid crystal display panel through vacuum-holding, holding the liquid crystal parallax barrier panel through the vacuum-holding, laminating the liquid crystal display panel and the liquid crystal parallax barrier panel via the ultraviolet curing resin while performing alignment thereof, releasing the liquid crystal display panel and the liquid crystal parallax barrier panel from the vacuum-holding, radiating ultraviolet rays to temporarily fix the liquid crystal display panel and the liquid crystal parallax barrier panel using the ultraviolet curing resin, and further radiating the ultraviolet rays to primarily cure the adhesive for adhesion of the liquid crystal display panel and the liquid crystal parallax barrier panel.

According to the present invention, adhesion of the liquid crystal parallax barrier panel and the liquid crystal display panel is conducted while releasing those panels from the vacuum-holding for temporary curing of the adhesive by ultraviolet rays. The temporary adhesion may be conducted in the state where any deformation does not occur in the substrate of the liquid crystal display panel or the liquid crystal parallax barrier panel. This may suppress unevenness of the liquid crystal layer thickness especially of the liquid crystal display panel caused by the substrate deformation. This makes it possible to realize the three dimensional display device free from the color shading.

### BRIEF DESCRIPTION OF THE DRAWINGS

FIG. 1 is a schematic cross section of the three dimensional display device according to the present invention;

FIG. 2 is a plan view showing a barrier electrode and a counter electrode of the liquid crystal parallax barrier panel;

FIG. 3 is a cross section of the liquid crystal parallax barrier panel;

FIG. 4 is a detailed cross section of the three dimensional display device according to the present invention;

FIG. 5 is a chart of the process steps of adhering the liquid crystal display panel and the liquid crystal parallax barrier panel according to the present invention;

FIG. 6 is a perspective view of a vacuum-holding plate;

FIG. 7 is a cross section showing the state where the liquid crystal display panel and the liquid crystal parallax barrier panel are vacuum-held, respectively;

FIG. 8 is a cross section showing the state where the liquid crystal display panel and the liquid crystal parallax barrier panel are laminated while being aligned;

FIG. 9 is a cross section showing the state where the liquid crystal display panel and the liquid crystal parallax barrier panel are released from the vacuum-holding, and the fine positional adjustment is conducted;

FIG. 10 is a cross section showing the state where the liquid crystal display panel and the liquid crystal parallax barrier panel are temporarily adhered by radiation of ultraviolet rays;

FIG. 11 is a table representing the effect of the liquid crystal display panel according to the present invention on the gap unevenness;

FIG. 12 is a chart of the generally employed process steps of adhering the liquid crystal display panel and the liquid crystal parallax barrier panel;

FIG. 13 is a view of temporary curing of the adhesive by the ultraviolet rays while vacuum-holding the liquid crystal display panel and the liquid crystal parallax barrier panel;

FIG. 14 is a cross section that shows a problem of the related art; and

FIG. 15 shows an example of the color shading in the display region owing to the vacuum-holding.

### DESCRIPTION OF THE PREFERRED EMBODIMENTS

The present invention will be described referring to the following embodiment.

### First Embodiment

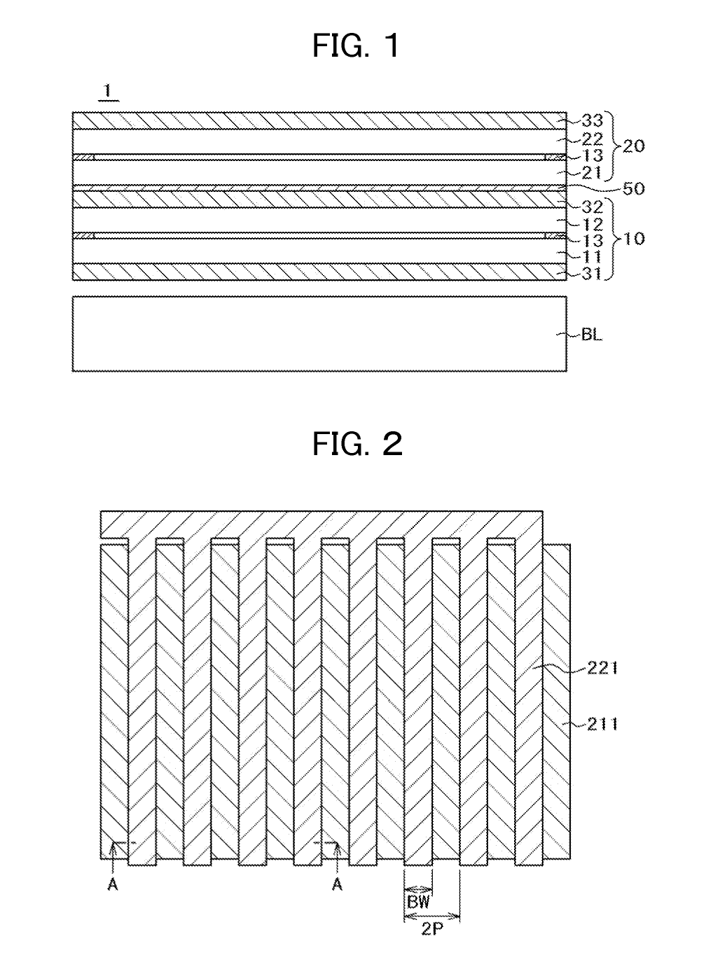

FIG. 1 is a cross section of a three dimensional display device 1 according to the present invention. Referring to FIG. 1, the liquid crystal parallax barrier panel 20 is laminated on the liquid crystal display panel 10 via the adhesive 50. A backlight BL is provided below a back surface of the liquid crystal display panel 10. The liquid crystal display panel 10 shown in FIG. 1 has the TFT substrate 11 having pixel electrodes and TFTs formed in a matrix, which is provided opposite the color filter substrate 12 having a color filter or the like formed via a seal material 13. The liquid crystal layer 40 is interposed between the TFT substrate 11 and the color filter substrate 12. The lower polarizing plate 31 is bonded to the lower side of the TFT substrate 11, and a middle polarizing plate 32 is bonded to the upper side of the color filter substrate 20. The liquid crystal display panel 10 is formed of the TFT substrate 11, the color filter substrate 12, the lower polarizing plate 31, and the middle polarizing plate 32.

The liquid crystal parallax barrier panel 20 as shown in FIG. 1 has a counter substrate 21 with a flat solid counter electrode 211, and a barrier substrate 22 provided with stripe barrier electrodes 221 via a seal material, which face each other. The liquid crystal layer 40 is interposed between the counter substrate 21 and the barrier substrate 22. The middle polarizing plate 32 provided on the liquid crystal display panel serves as the lower polarizing plate for the liquid crystal parallax barrier panel 20. An upper polarizing plate 33 is applied to the outer surface of the barrier substrate 22. The liquid crystal parallax barrier panel 20 will be hereinafter defined as the structure formed of the counter substrate 21, the barrier substrate 22 and the upper polarizing plate 33.

The liquid crystal display panel 10 and the liquid crystal parallax barrier panel 20 are formed using the adhesive 50 as the ultraviolet curing resin. As the ultraviolet curing resin 50, such product as SVR 1100, SVR 1320, and SVR 1240H by Sony Chemicals Corporation may be used. As FIG. 1 shows, the backlight BL is provided below the back surface of the liquid crystal display panel 10.

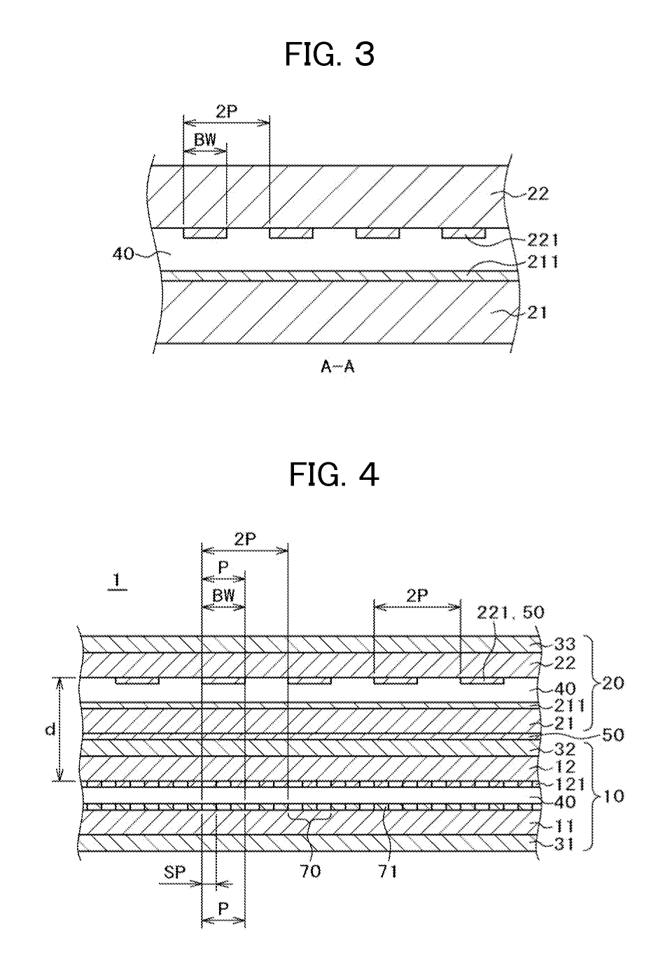

FIG. 2 is a plan view of the counter electrode 21 and the barrier electrode 22 of the liquid crystal parallax barrier panel 20. Referring to FIG. 2, the stripe barrier electrode 22 is provided on the flat solid counter electrode 21 having the not shown liquid crystal layer 40 interposed therebetween. FIG. 3 is a cross section taken on line A-A of FIG. 2. Referring to FIG. 3, the flat solid counter electrode 211 is formed on the counter substrate 21, above which the barrier substrate 22 with the barrier electrodes 221 is provided via the liquid crystal layer 40. Both the counter electrode 211 and the barrier electrodes 221 are formed of ITO (Indium Tin Oxide) as the transparent conducting layer.

Referring to FIG. 3, the liquid crystal parallax barrier panel 20 is driven in TN (Twisted Nematic) mode. Application of voltage between the barrier electrode 221 and the counter electrode 211 prevents transmission of light through the part corresponding to the barrier electrode 221. Then the stripe barrier pattern is formed on the liquid crystal parallax barrier panel 20, which allows three dimensional display. If the voltage is not applied between the barrier electrode 221 and the counter electrode 211, the barrier pattern is not generated. As a result, the image on the liquid crystal display panel 10 is two dimensionally displayed.

FIG. 4 is a detailed cross section of the three dimensional display device 1 shown in FIG. 1. Referring to FIG. 4, the liquid crystal display panel 10 including the lower polarizing plate 31, the TFT substrate 11, the liquid crystal layer 40, the color filter substrate 12, and the middle polarizing plate 32, and the liquid crystal parallax barrier panel 20 including the counter substrate 21, the liquid crystal layer 40, the barrier substrate 22, and the upper polarizing plate 33 are laminated using the adhesive 50. The liquid crystal display panel 10 shown in FIG. 4 is driven in the IPS mode, and the liquid crystal parallax barrier panel 20 is driven in the TN mode.

As FIG. 4 shows, the position for viewing the three dimensional image is determined to assume a distance d between the position of the color filter of the liquid crystal display panel 10, which is formed inside the color filter substrate 12, and the position of the barrier electrode 221 of the liquid crystal parallax barrier panel 20. In order to adjust the position for viewing the expected two-dimensional image, the distance d is changed, in most cases, by adjusting the thickness of the substrate of the liquid crystal parallax barrier panel 20. It is a matter of common occurrence that the substrate of the liquid crystal parallax barrier panel 20 is thicker than the substrate of the liquid crystal display panel 10.

As FIG. 4 shows, the liquid crystal display panel 10 has pixels 70 arranged at pitches P, including sub-pixels 71 each formed of red (R), green (G) and blue (B), which are arranged at pitches SP. The liquid crystal parallax barrier panel 20 includes the barrier electrodes 221 at the pitch twice the pixel pitch P. The width BW of the barrier electrode 221 is the same as the pixel pitch P. The viewer will recognize the three dimensional image by viewing the image on the liquid crystal display panel 10 via the barrier pattern. It is therefore essential to have alignment of the liquid crystal display panel 10 and the liquid crystal parallax barrier panel 20.

Meanwhile, each plate thickness of the TFT substrate 11, the color filter substrate 12 of the liquid crystal display panel 10, and the counter substrate 21 and the barrier substrate 22 of the liquid crystal parallax barrier panel 20 is 0.18 mm. They may be easily deformed under the stress generated when adhering the liquid crystal display panel 10 and the liquid crystal parallax barrier panel 20. Especially when the TFT substrate 11 or the color filter substrate 12 of the liquid crystal display panel 10 is deformed, the thickness of the liquid crystal layer 40 is changed, resulting in color shading. The present invention allows accurate alignment of the liquid crystal display panel 10 and the liquid crystal parallax barrier panel 20, and prevention of deformation of especially the substrates of the liquid crystal display panel 10, thus preventing the color shading.

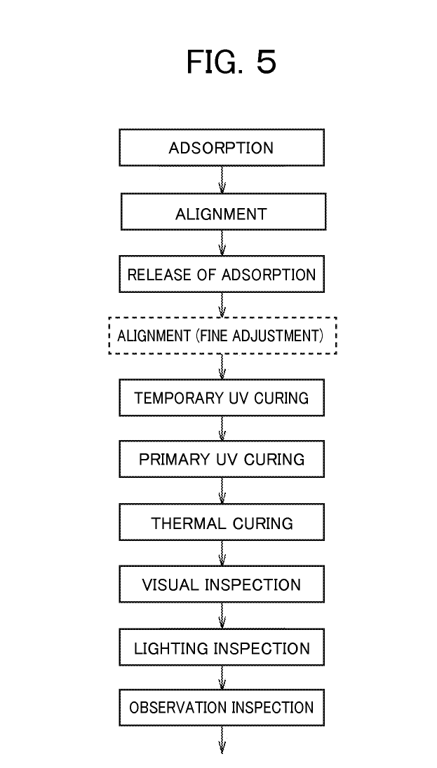

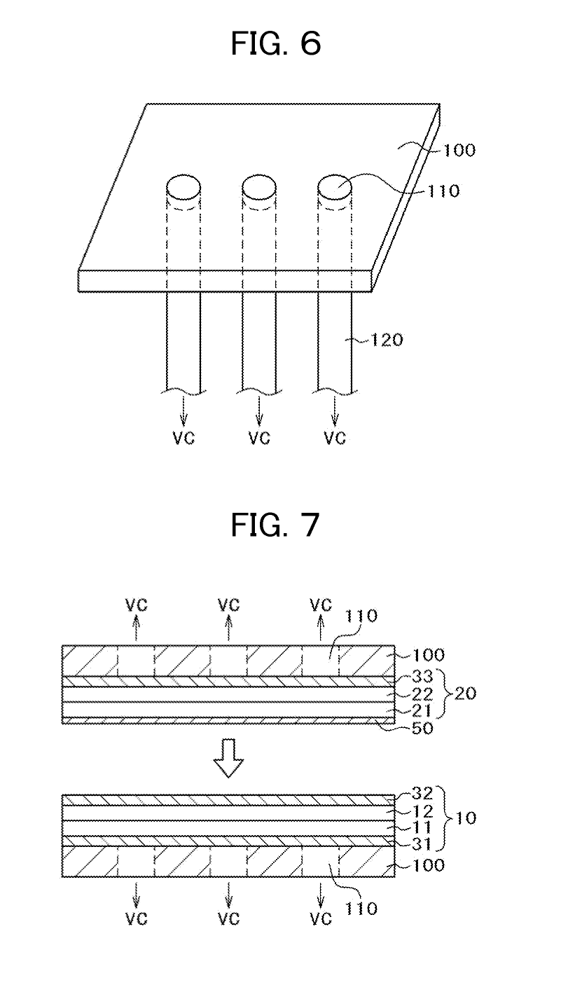

FIG. 5 is a chart of the process steps of adhering the liquid crystal display panel 10 and the liquid crystal parallax barrier panel 20 according to the present invention. Referring to FIG. 5, the “adsorption” represents the step of adsorbing the liquid crystal display panel 10 and the liquid crystal parallax barrier panel 20 to the vacuum-holding plates by vacuum-holding, respectively so as to be movable. For the vacuum-holding, the liquid crystal display panel 10 or the liquid crystal parallax barrier panel 20 is mounted on the vacuum-holding plate 100 having the adsorption holes 110 as shown in FIG. 6. Then vacuuming is performed via vacuum ducts 120 connected to the adsorption holes 110 for adsorption.

Referring to FIG. 6, the arrow marks and the codes VC represent the vacuuming state, which applies to the subsequent drawings.

FIG. 7 shows the state where the liquid crystal parallax barrier panel 20 and the liquid crystal display panel 10 are adsorbed to the vacuum-holding plates 100, respectively just before they are adhered. Referring to FIG. 7, the adhesive 50 as the ultraviolet curing resin is applied to the surface opposite the counter substrate 12 of the liquid crystal display panel 10. The adhesive 50 is adhered to the middle polarizing plate 32 applied to the liquid crystal display panel 10.

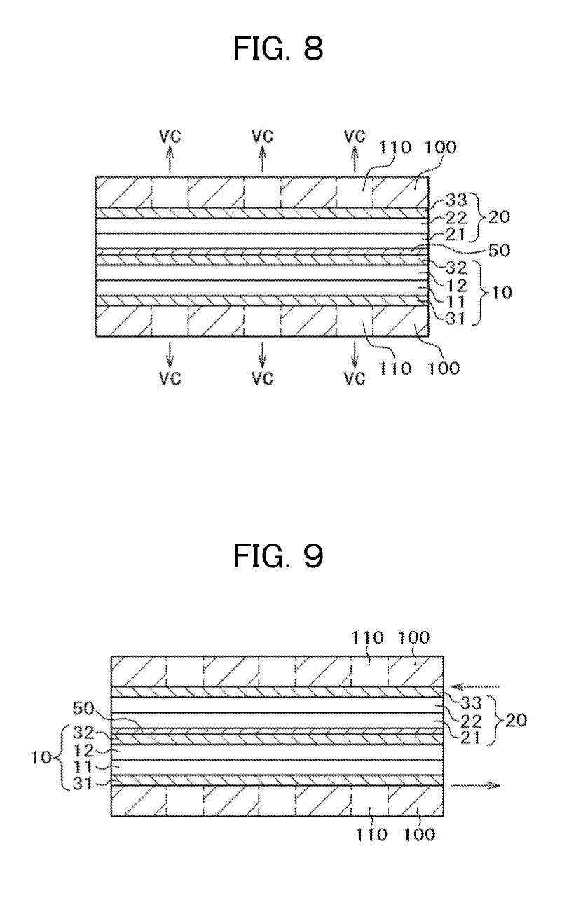

FIG. 8 shows the state where the liquid crystal display panel 10 and the liquid crystal parallax barrier panel 20 are adhered via the adhesive 50. FIG. 8 corresponds to the step of “alignment” in the chart of the process steps shown in FIG. 5. In this state, the alignment of the liquid crystal display panel 10 and the liquid crystal parallax barrier panel 20 is performed using the alignment mark and the like, and they are vacuum-held to the vacuum-holding plates 100. In this state, as FIG. 14 shows, the liquid crystal parallax barrier panel 20 or the liquid crystal display panel 10 is deformed under the stress resulting from the vacuum-holding.

The characteristic of the present invention is to “release the adsorption” while keeping the liquid crystal display panel 10 and the liquid crystal parallax barrier panel 20 aligned. In other words, as FIG. 9 shows, the vacuum-holding is released while holding the liquid crystal display panel 10 and the liquid crystal parallax barrier panel 20 mounted onto the vacuum-holding plates 100. Unlike FIG. 8, FIG. 9 shows that there are no arrow marks and codes VC with respect to the adsorption holes 110 for the vacuum-holding. In such a state, the adhesive 50 is not cured, and kept in the liquid state. When releasing the vacuum-holding in this state, the adhesive 50 is in the liquid state but exhibits elasticity. This may have the positional relationship between the liquid crystal display panel 10 and the liquid crystal parallax barrier panel 20 inconsistent with the position that has been aligned using the alignment mark.

The “alignment (fine adjustment)” step shown in FIG. 5 is performed to correct the inconsistency. The horizontal arrow marks shown in FIG. 9 represent the fine adjustment of the respective positions. Referring to FIG. 9, arrow marks with respect to the liquid crystal parallax barrier panel 20 and the liquid crystal display panel 10 are oppositely directed, indicating the state where the respective positions are finely adjusted. After the release of the vacuum-holding, if there is no misalignment between the liquid crystal display panel 10 and the liquid crystal parallax barrier panel 20, the “alignment (fine adjustment) step is not required. Therefore, this step is enclosed by the dotted line.

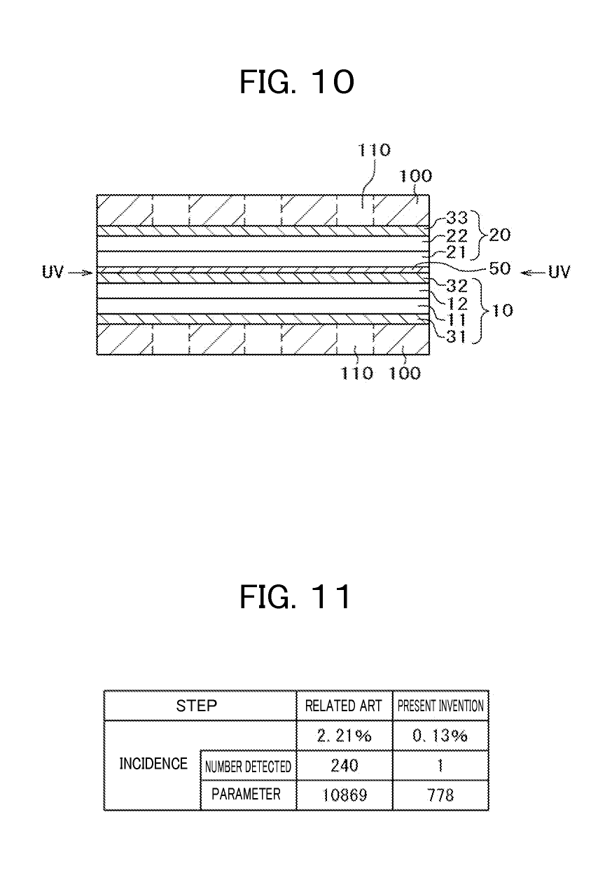

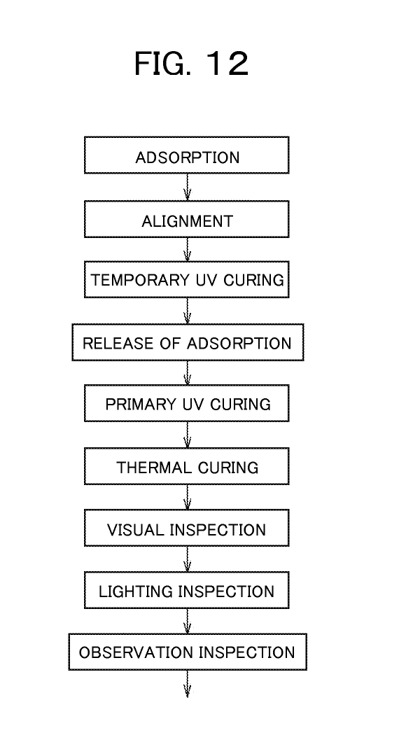

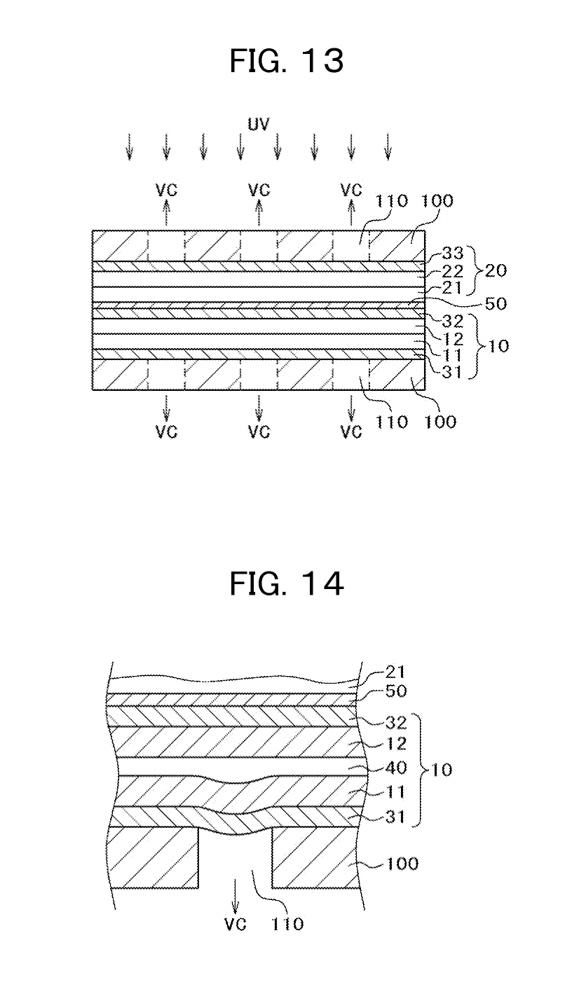

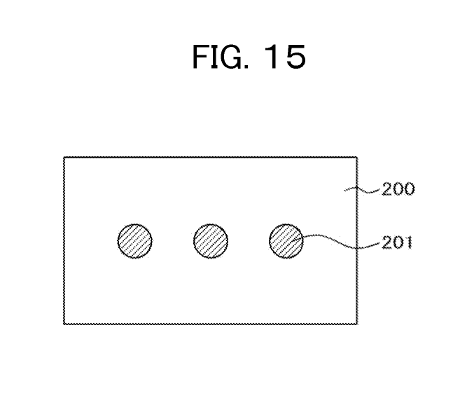

During the fine positional adjustment, the liquid crystal parallax barrier panel 20 and the liquid crystal display panel 10 are not vacuum-held as FIG. 9 shows. Then they have no substrate deformation as shown in FIG. 14. In the aforementioned state, radiation of ultraviolet rays is performed to temporarily adhere the liquid crystal parallax barrier panel 20 and the liquid crystal display panel 10 as shown in FIG. 10. This step represents the “temporary UV curing” as shown in FIG. 5. In other words, when performing the temporary adhesion, the liquid crystal parallax barrier panel 20 and the liquid crystal display panel 10 have no substrate deformation. Accordingly, there is no unevenness in the layer thickness of the liquid crystal layer 40, and the resultant liquid crystal display panel 10 has no color shading. As FIG. 10 shows, radiation of ultraviolet rays is applied from the side of the portion where the liquid crystal display panel and the liquid crystal parallax barrier panel are adhered.

Thereafter, the adhesive 50 is further thermally cured as shown in FIG. 5 so as to complete adhesion of the liquid crystal display panel 10 and the liquid crystal parallax barrier panel 20. If the adhesive 50 formed of the ultraviolet curing resin is sufficiently cured only by radiation of ultraviolet rays, the step of thermal curing is not necessarily required.

The color shading of the three dimensional display device 1 configured as shown in FIG. 1 often occurs especially by deformation of the substrate of the liquid crystal display panel 10. In other words, the liquid crystal display panel 10 is formed using IPS method or VA method with excellent viewing angle property. Meanwhile, the liquid crystal parallax barrier panel 20 is formed using the TN method. This is because the IPS method or the VA method is more likely to be influenced by the substrate deformation, that is, unevenness in the layer thickness of the liquid crystal layer 40. If the substrate thickness of the liquid crystal parallax barrier panel 20 is larger than that of the liquid crystal display panel 10, the deformation in the liquid crystal parallax barrier panel 20 is smaller, and accordingly, influence on the color shading is unlikely to be revealed.

The visual inspection of the thus configured three dimensional display device, and then lighting inspection are performed to measure the degree of color shading of the image. Finally, the three dimensional image is actually observed in order to inspect whether the positional relationship between the liquid crystal display panel 10 and the liquid crystal parallax barrier panel 20 is correctly set.

FIG. 11 represents the measurement results with respect to incidence of the gap unevenness, that is, the color shading observed in the product of specific type by comparison between the three dimensional display device manufactured according to the present invention and the three dimensional display device as related art. Referring to FIG. 11, the gap unevenness of the three dimensional display device as related art was found in 240 units relative to the parameter of 10869 units, resulting in the fraction defective of 2.21%. Meanwhile, the gap unevenness of the three dimensional display device according to the present invention was found only in 1 unit relative to the parameter of 778 units, resulting in the fraction defective of 0.13%.

Simultaneously with the measurement, the fraction defective was also measured in the “observation inspection” as the step of inspecting whether or not the three dimensional image is appropriately displayed. The observation inspection is the step to detect whether or not the positional relationship between the liquid crystal display panel 10 and the liquid crystal parallax barrier panel 20 is appropriately set. As a result, in comparison with the fraction defective of 1.2% measured from the observation inspection of the products manufactured as related art, the fraction defective from the observation inspection of the products manufactured according to the present invention measured 1.3%, which shows substantially no significant difference. In other words, according to the present invention, the vacuum-holding is released before conducting the temporary curing of the adhesive 50. The resultant influence hardly affects the positional relationship between the liquid crystal display panel 10 and the liquid crystal parallax barrier panel 20.

This clearly shows the significant effect of solving the color shading of the three dimensional display device manufactured according to the present invention. The alignment failure of the liquid crystal display panel 10 and the liquid crystal parallax barrier panel 20 does not increase as compared to the related art. The present invention exhibits the significant effect especially when the TFT substrate 11 or the color filter substrate 12 of the liquid crystal display panel 10 is thin, that is, the thickness of 0.2 mm or smaller.

In the aforementioned process steps, the middle polarizing plate 32 is provided on the liquid crystal display panel 10, and the adhesive 50 is applied to the side of the liquid crystal parallax barrier panel 20 for adhesion. However, the middle polarizing plate 32 may be provided on the liquid crystal parallax barrier panel 20, and the adhesive 50 may be applied to the side of the liquid crystal display panel 10. Alternatively, both the middle polarizing plate 32 and the adhesive 50 may be applied to any side of the liquid crystal display panel 10 or the liquid crystal parallax barrier panel 20.

What is claimed is:

1. A method of manufacturing a three dimensional display device, which adheres a liquid crystal parallax barrier panel with a barrier substrate and a counter substrate to a liquid crystal display panel with a TFT substrate and a color filter substrate at a side of the color filter substrate using an adhesive formed of an ultraviolet curing resin, and provides a backlight below a back surface of the liquid crystal display panel, the method comprising the steps of:
holding the liquid crystal display panel through vacuum-holding;
holding the liquid crystal parallax barrier panel through the vacuum-holding;
laminating the liquid crystal display panel and the liquid crystal parallax barrier panel via the ultraviolet curing resin while performing alignment thereof;
releasing the liquid crystal display panel and the liquid crystal parallax barrier panel from the vacuum-holding;
radiating ultraviolet rays to temporarily fix the liquid crystal display panel and the liquid crystal parallax barrier panel using the ultraviolet curing resin; and
further radiating the ultraviolet rays to primarily cure the adhesive for adhesion of the liquid crystal display panel and the liquid crystal parallax barrier panel.

2. The method of manufacturing the three dimensional display device according to claim 1, wherein a plate thickness of the TFT substrate or the color filter substrate of the liquid crystal display panel is equal to or smaller than 0.2 mm.

3. The method of manufacturing the three dimensional display device according to claim 2, wherein the adhesive is further thermally cured after primarily curing by ultraviolet rays.

4. The method of manufacturing the three dimensional display device according to claim 2, wherein after releasing the liquid crystal display panel and the liquid crystal parallax barrier panel from the vacuum-holding, the liquid crystal display panel and the liquid crystal parallax barrier panel are aligned.

5. The method of manufacturing the three dimensional display device according to claim 2, wherein the liquid crystal display panel is formed through IPS method.
